(19) United States
(12) Patent Application Publication
(10) Pub. No.: US 2018/0033319 A1
(43) Pub. Date: Feb. 1, 2018

(54) SYSTEMS AND METHODS FOR PROVIDING AN INTEGRATED TCAS AND DME SYSTEM USING AN OMNIDIRECTIONAL ANTENNA

(71) Applicant: Aviation Communication & Surveillance Systems LLC, Phoenix, AZ (US)

(72) Inventor: James R. TROXEL, Glendale, AZ (US)

(21) Appl. No.: 15/408,945

(22) Filed: Jan. 18, 2017

Related U.S. Application Data
(60) Provisional application No. 62/279,919, filed on Jan. 18, 2016.

(51) Int. Cl. G08G 5/04; G01S 13/93; G08G 5/00; H01Q 1/28

(52) U.S. Cl. CPC G08G 5/045; H01Q 1/28; G01S 13/9303; G08G 5/0013; G08G 5/0008; G08G 5/0078

(57) ABSTRACT

Various avionics systems may benefit from appropriate integration of distance measurement equipment and traffic collision avoidance systems, or the like, using an omnidirectional antenna. A system can include an avionics processor. The system can also include a top antenna receiver configured to connect to a top antenna. The avionics processor can be configured to communicate using the top antenna. The system can further include a bottom antenna receiver configured to connect to a bottom antenna. The avionics processor can be configured to communicate using the bottom antenna. The bottom antenna can be an omnidirectional antenna. The system can additionally include a distance measure equipment receiver configured to be connected to the bottom antenna. The system can also include a distance measure equipment processor configured to measure distance using the bottom antenna.

### CROSS-REFERENCE TO RELATED APPLICATION

This application is related to and claims the benefit and priority of U.S. Provisional Patent Application No. 62/279,919, filed Jan. 18, 2016, the entirety of which is hereby incorporated herein by reference.

### BACKGROUND

### Field

Various avionics systems may benefit from appropriate integration of distance measurement equipment and traffic collision avoidance systems, or the like, using an omnidirectional antenna.

### Description of the Related Art

FIG. 1 illustrates a simplified block diagram of a typical installed traffic collision avoidance system or traffic alert and collision avoidance system (TCAS) system. TCAS-II systems which are approved to TSO-C119 and meet requirements in Radio Technical Commission for Aeronautics (RTCA) document DO-185 may require top and bottom antennas connected to the TCAS computer unit for generating interrogations to airborne intruders and processing replies from the intruder's transponder system (e.g., Mode S, air traffic control radar beacon system (ATCRBS), or identification, friend or foe (IFF)).

The TCAS-II system may perform most interrogation and reply processing out of the top L-band directional antenna, per the DO-185 Minimum Operational Performance Specification (MOPS). The bottom L-band antenna may be required in order to provide adequate surveillance coverage when the top antenna's performance is degraded due to aircraft geometry or other obstructions. DO-185 may require the top antenna to be directional and perform directional interrogation and reply processing; however, the bottom antenna may either be directional or omnidirectional.

TCAS-II systems may operate with either a bottom L-band directional or L-band omnidirectional antenna. TCAS-II systems may be employed on a number of different aircraft types with a bottom omnidirectional antenna and provide desired performance. One advantage of employing a bottom omnidirectional antenna is a significant installation cost and weight savings. The omnidirectional antenna's cost is a fraction of the cost of a directional antenna. In addition, a directional antenna requires 4 coaxial cables between the TCAS computer unit and the antenna. An omnidirectional antenna reduces this to a single coaxial cable.

As shown in FIG. 1, an aircraft may include transponders, such as Mode S diversity transponders that are separate from the TCAS system. Typically, the Mode S diversity transponders have their own antennas, and may communicate across an interface to the TCAS system. In the case of products in which the TCAS and transponder (XPDR) are integrated, they share the same antennas.

Distance measuring equipment (DME) (not shown in FIG. 1) which is approved to TSO-C66 and meets requirements in RTCA document DO-189 may use a bottom L-band omnidirectional antenna. Since L-band omnidirectional antennas have a wide frequency response, many of the commercially available antennas will meet the requirements of multiple L-band systems (e.g., TCAS, transponder, DME) and therefore will have multiple TSO approvals for the various systems.

### SUMMARY

A system, according to certain embodiments of the present invention, can include an avionics processor. The system can also include a top antenna receiver configured to connect to a top antenna. The avionics processor can be configured to communicate using the top antenna. The system can further include a bottom antenna receiver configured to connect to a bottom antenna. The avionics processor can be configured to communicate using the bottom antenna. The bottom antenna can be an omnidirectional antenna. The system can additionally include a distance measure equipment receiver configured to be connected to the bottom antenna. The system can also include a distance measure equipment processor configured to measure distance using the bottom antenna.

A method, in certain embodiments of the present invention, can include receiving a first avionics signal at an avionics processor via a top antenna and top antenna receiver. The method can also include receiving a second avionics signal at the avionics processor via a bottom antenna and a bottom antenna receiver. The bottom antenna can be an omnidirectional antenna. The method can further include performing a distance measure equipment function using the bottom antenna.

According to certain embodiments of the present invention, an apparatus can include means for receiving a first avionics signal via a top antenna. The apparatus can also include means for receiving a second avionics signal via a bottom antenna. The bottom antenna can include an omnidirectional antenna. The apparatus can further include means for processing the first avionics signal and the second avionics signal. The apparatus can additionally include means for performing a distance measure equipment function while sharing the bottom antenna with the means for processing.

### BRIEF DESCRIPTION OF THE DRAWINGS

For proper understanding of the invention, reference should be made to the accompanying drawings, wherein:

FIG. 1 illustrates a simplified block diagram of a typical installed TCAS system.

FIG. 2 illustrates an example of a block diagram of system according to certain embodiments of the present invention.

FIG. 3 illustrates a system according to certain embodiments of the present invention.

FIG. 4 illustrates a method according to certain embodiments of the present invention.

### DETAILED DESCRIPTION

In order to provide increased integration in aircraft avionics and reduce the cost and weight, or for other reasons, it may be desirable to integrate the DME function into existing systems, such as a TCAS system. This may remove a DME unit from the aircraft and allow the TCAS and DME system to share common resources, such as radio frequency (RF), processing, input/output (I/O), and antennas.

Certain embodiments of the present invention may provide for an integrated TCAS-II and DME system in which both TCAS-II and DME function in the system may share the use of a common bottom omnidirectional antenna.

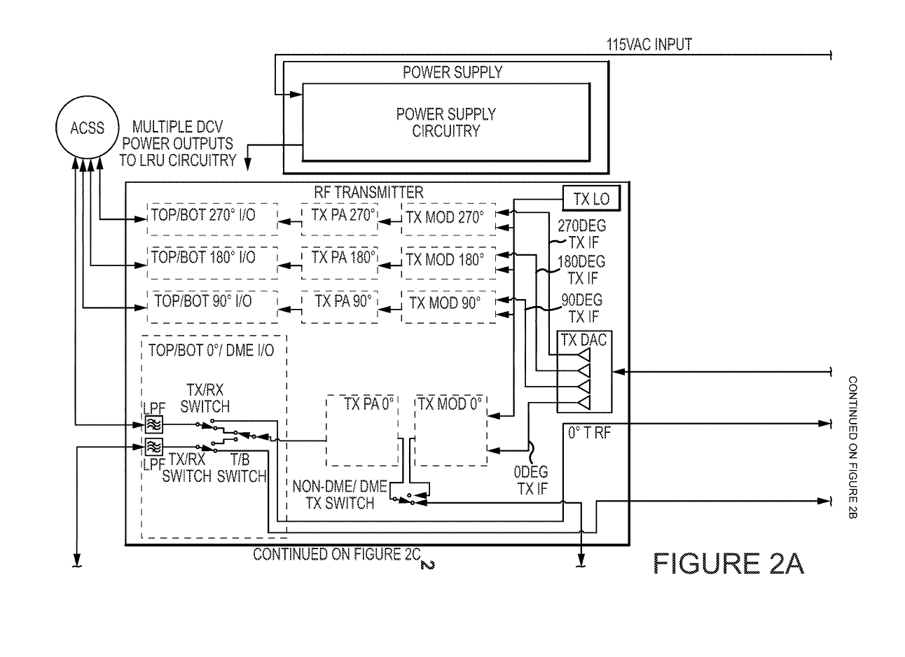

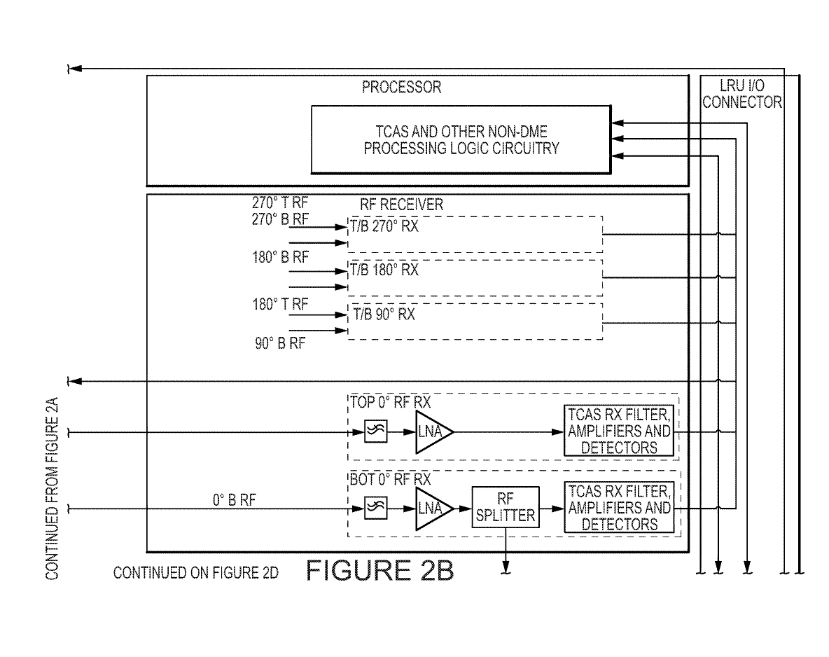

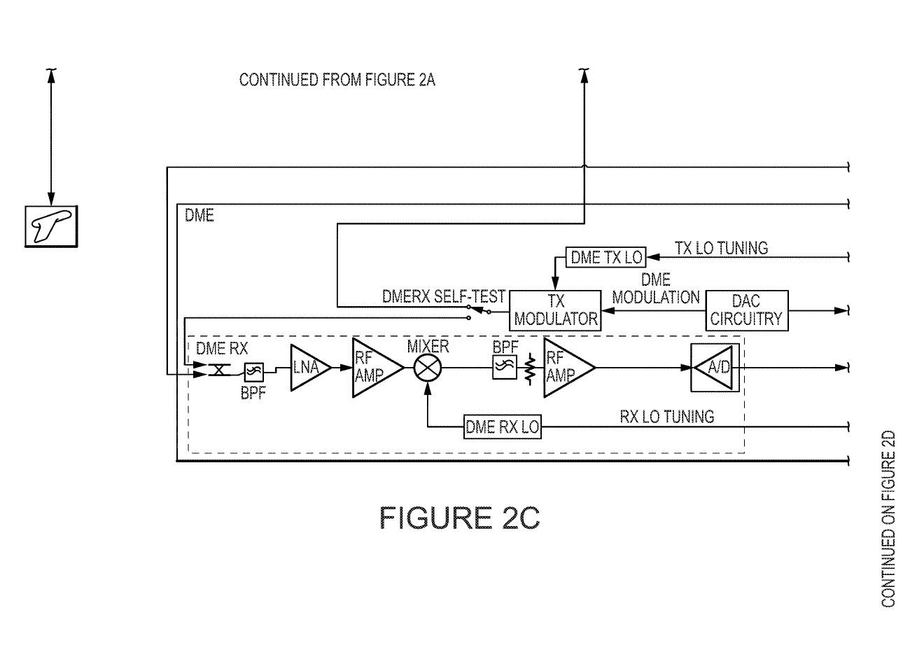

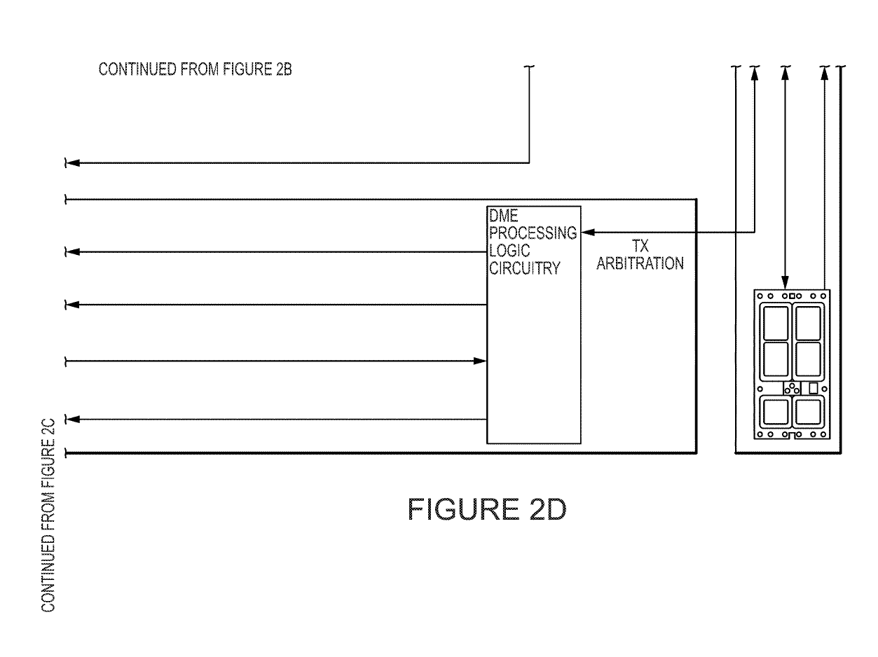

FIG. 2 illustrates an example of a block diagram of system according to certain embodiments of the present invention. In this example embodiment of a system, the system may provide the following circuitry in which the TCAS-II function may be implemented: a power supply, a processor, an RF transmitter, an RF receiver and an I/O connector.

The RF transmitter circuitry may be connected to a top directional antenna and a bottom omnidirectional antenna. TCAS-II transmissions may be provided on the bottom omnidirectional antenna through a power amplifier (e.g., transmission (TX) power amplifier (PA) 0 degrees). The bottom omnidirectional antenna may be connected through the 0 degree I/O switch block component on the RF transmitter circuitry to the bottom 0 degree receiver component on the RF receiver circuitry.

The DME function may be added to the system as additional circuitry and may perform DME processing, DME system I/O, DME receiver and DME transmitter modulation functions. In an example embodiment, the DME function may share the L-band transmitter with the TCAS-II function. The TX PA 0 degree device may have an RF switch at the input that may allow either the TCAS-II modulator to be connected to the amplifier (TX MOD 0) or the DME modulator to be connected to the amplifier (Tx Modulator block shown in FIG. 2 is driven by the DME TX LO and receives the DME MODULATION signal). The output of the TX PA 0 block may be connected to the bottom omnidirectional antenna through the 0 DEG I/O component. The receiver low noise amplifier (LNA) on the receiver circuit card assembly (CCA) may be connected to the bottom omnidirectional antenna through the 0 deg I/O block on the transmitter CCA. The output of the bottom 0 LNA may go to an RF splitter, with one output that may go to the TCAS-II receiver and the other may go to the DME receiver on the DME CCA.

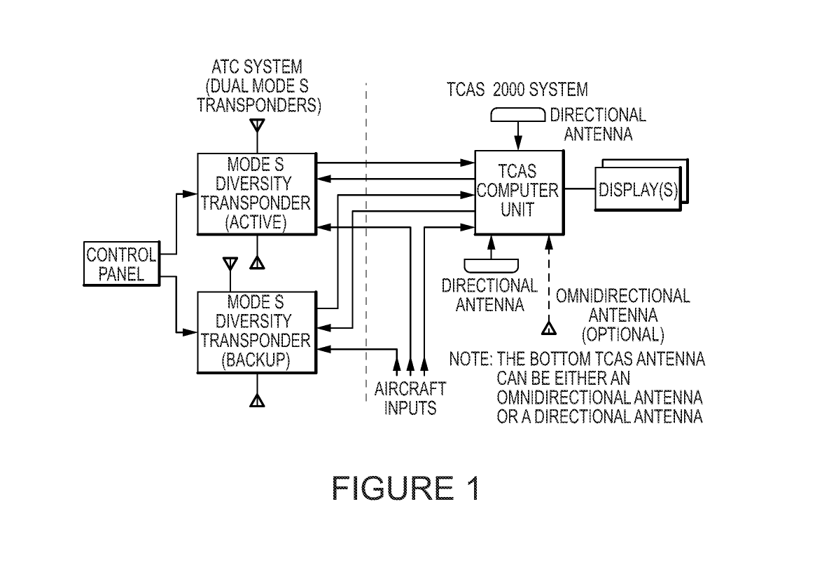

As also shown in FIG. 1, a single line replaceable unit (LRU) connector may interface each of the power supply, the processor unit, the RF transmitter and receiver, and the DME. Thus, the DME may be implemented as a CCA on the LRU. The LRU may provide an interface to a top 0 degree RF RX, a bottom 0 degree RF RX, as well as various directional receivers, include a 270 degree receiver, a 180 degree receiver, and a 90 degree receiver.

Other embodiments of the present invention are possible, which may include but are not limited to the use of a separate transmitter for TCAS-II and DME functions which may be connected to the bottom omnidirectional L-Band antenna.

Additionally, the DME and TCAS-II functions may share common receiver, transmitter modulation, processing, power supply and system I/O functions.

In addition, certain embodiments of the present invention may include separate LRUs for TCAS-II and DME, which may be connected to a common bottom omnidirectional L-band antenna through any desired means.

In addition to a TCAS-II system, the DME could be integrated with a TCAS-I system (TSO-C118) or a traffic awareness system (TAS) system (TSO-C47) or an ADS-B IN system (1090 MHz as described in TSO-C166b; and/or UAT as described in TSO-C154c). All systems can use a bottom omnidirectional antenna.

The TCAS-II and DME system may also implement other functions, which may share or have separate resources for implementing the desired functions.

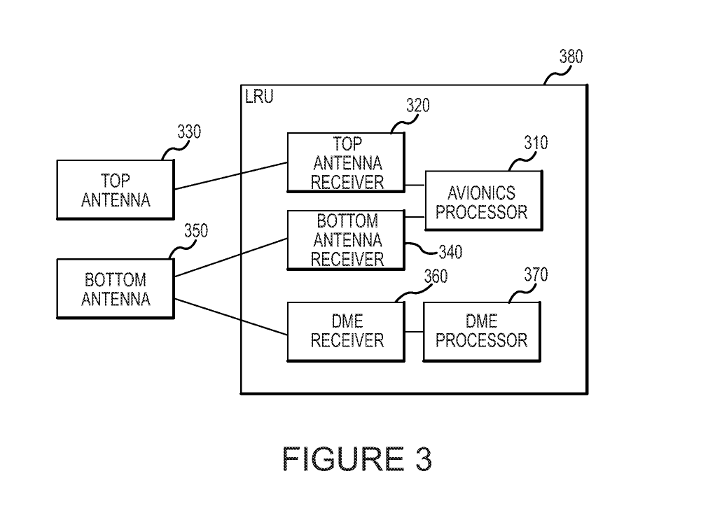

FIG. 3 illustrates a system according to certain embodiments of the present invention. As shown in FIG. 3 a system can include an avionics processor 310. The avionics processor can be a processor of a traffic collision avoidance system or traffic alert and collision avoidance system. Alternatively, the avionics processor can be a processor of a traffic awareness system or an ADS-B IN system.

The system can also include a top antenna receiver 320 configured to connect to a top antenna 330. The avionics processor 310 can be configured to communicate using the top antenna 330.

The system can further include a bottom antenna receiver 340 configured to connect to a bottom antenna 350. The avionics processor 310 can be configured to communicate using the bottom antenna 350. The bottom antenna 350 can be an omnidirectional antenna.

The system can further include a distance measure equipment receiver 360 configured to be connected to the bottom antenna 350. The system can also include a distance measure equipment processor 370 configured to measure distance using the bottom antenna 350.

The avionics processor 310, top antenna receiver 320, bottom antenna receiver 340, distance measure equipment receiver 360, and distance measure equipment processor 370 can be provided as a single line replaceable unit 380. The distance measure equipment processor 370 can be provided on a different circuit card assembly from the avionics processor 310.

The distance measure equipment processor 370 can be provided on a same circuit card assembly as the distance measure equipment receiver 360. The distance measurement equipment receiver 360 can be configured to receive a same signal as the bottom antenna receiver 340 from the bottom antenna 350. This can involve a splitter in the path from the bottom antenna 350. The location of the splitter along the signal can be selected according to convenience or for other reasons.

The distance measure equipment processor and the avionics processor can be implemented on a same chip or a same circuit card assembly. Thus, for example, a single processor can incorporate both TCAS processing and DME processing functionality.

Likewise, a single transmitter or a single receiver, or both, may be shared between the avionics and DME functions. Thus, there may be a reduction in the amount of hardware components used to implement certain embodiments of the present invention.

As illustrated in FIG. 2, other equipment such as power supply and LRU interface equipment can be shared between the avionics and DME functions. Thus, both TCAS and DME can serve as a single LRU in certain embodiments of the present invention.

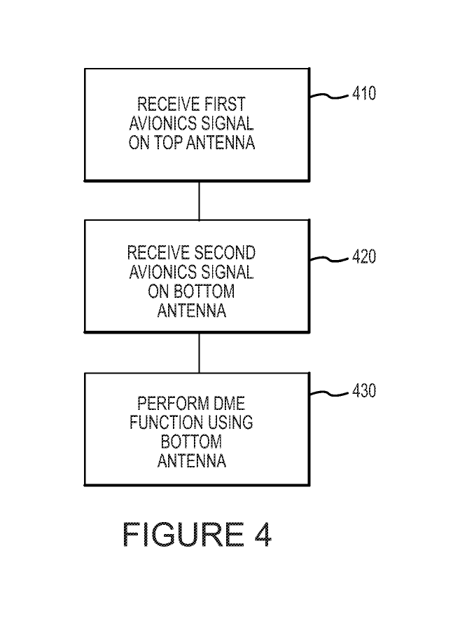

FIG. 4 illustrates a method according to certain embodiments of the present invention. The method can include, at 410, receiving a first avionics signal at an avionics processor via a top antenna and top antenna receiver. The avionics processor can be a traffic collision avoidance system or traffic alert and collision avoidance system. Alternatively, the avionics processor can be a traffic awareness system or an ADS-B IN system.

The method can also include, at 420, receiving a second avionics signal at the avionics processor via a bottom antenna and a bottom antenna receiver. The bottom antenna can be an omnidirectional antenna. The method can further include, at 430, performing a distance measure equipment function using the bottom antenna.

The avionics processor, top antenna receiver, and bottom antenna receiver can be provided as a single line replaceable unit together with a distance measure equipment receiver and a distance measure equipment processor providing the distance measure equipment function. This is illustrated, by way of example, in FIGS. 2 and 3.

The distance measure equipment processor can be provided on a different circuit card assembly from the avionics processor. Likewise, the distance measure equipment processor can be provided on a same circuit card assembly as the distance measure equipment receiver. The distance measurement equipment receiver can be configured to receive a same signal as the bottom antenna receiver from the bottom antenna.

The system of FIG. 2 and/or FIG. 3 can be used as means for performing the method according to FIG. 4.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

We claim:

1. A system, comprising:
an avionics processor;
a top antenna receiver configured to connect to a top antenna, wherein the avionics processor is configured to communicate using the top antenna;
a bottom antenna receiver configured to connect to a bottom antenna, wherein the avionics processor is configured to communicate using the bottom antenna, wherein the bottom antenna comprises an omnidirectional antenna;
a distance measure equipment receiver configured to be connected to the bottom antenna; and
a distance measure equipment processor configured to measure distance using the bottom antenna.

2. The system of claim 1, wherein the avionics processor comprises a processor of a traffic collision avoidance system or a traffic alert and collision avoidance system.

3. The system of claim 1, wherein the avionics processor comprises a processor of a traffic awareness system or ADS-B IN system.

4. The system of claim 1, wherein the avionics processor, top antenna receiver, bottom antenna receiver, distance measure equipment receiver, and distance measure equipment processor are provided as a single line replaceable unit.

5. The system of claim 1, wherein the distance measure equipment processor is provided on a different circuit card assembly from the avionics processor.

6. The system of claim 1, wherein the distance measure equipment processor is provided on a same circuit card assembly as the distance measure equipment receiver.

7. The system of claim 1, wherein the distance measurement equipment receiver is configured to receive a same signal as the bottom antenna receiver from the bottom antenna.

8. The system of claim 1, wherein the distance measure equipment processor and the avionics processor are implemented on a same chip or a same circuit card assembly.

9. A method, comprising:
receiving a first avionics signal at an avionics processor via a top antenna and top antenna receiver;
receiving a second avionics signal at the avionics processor via a bottom antenna and a bottom antenna receiver, wherein the bottom antenna comprises an omnidirectional antenna; and
performing a distance measure equipment function using the bottom antenna.

10. The method of claim 9, wherein the avionics processor comprises a traffic collision avoidance system or traffic alert and collision avoidance system.

11. The method of claim 9, wherein the avionics processor comprises a traffic awareness system or ADS-B IN system.

12. The method of claim 9, wherein the avionics processor, top antenna receiver, and bottom antenna receiver are provided as a single line replaceable unit together with a distance measure equipment receiver and a distance measure equipment processor providing the distance measure equipment function.

13. The method of claim 12, wherein the distance measure equipment processor is provided on a different circuit card assembly from the avionics processor.

14. The method of claim 12, wherein the distance measure equipment processor is provided on a same circuit card assembly as the distance measure equipment receiver.

15. The method of claim 12, wherein the distance measurement equipment receiver is configured to receive a same signal as the bottom antenna receiver from the bottom antenna.

16. The method of claim 12, wherein the distance measure equipment processor and the avionics processor are implemented on a same chip or a same circuit card assembly.

17. An apparatus, comprising:
means for receiving a first avionics signal via a top antenna;
means for receiving a second avionics signal via a bottom antenna, wherein the bottom antenna comprises an omnidirectional antenna;
means for processing the first avionics signal and the second avionics signal; and
means for performing a distance measure equipment function while sharing the bottom antenna with the means for processing.

18. The apparatus of claim 17, wherein the means for processing comprises a traffic collision avoidance system or traffic alert and collision avoidance system.

19. The apparatus of claim 17, wherein the means for processing comprises a traffic awareness system or ADS-B IN system.

20. The apparatus of claim 17, wherein the sharing the bottom antenna comprises receiving a same signal from the bottom antenna by both the means for processing and the means for performing the distance measure equipment function.
